(19) United States
(12) Patent Application Publication
(10) Pub. No.: US 2010/0122747 A1
(43) Pub. Date: May 20, 2010

(54) Composite Structures for Hydrogen Storage and Transfer

(75) Inventor: James G. Blencoe, Harriman, TN (US)

Correspondence Address: Baker Botts L.L.P, 910 Louisiana Street, One Shell Plaza, HOUSTON, TX, 77002, US

(73) Assignee: Hydrogen Discoveries, Inc., Oak Ridge, TN (US)

(21) Appl. No.: 12/619,212

(22) Filed: Nov. 16, 2009

Related U.S. Application Data
(63) Continuation-in-part of application No. 11/852,364, filed on Sep. 10, 2007.
(60) Provisional application No. 61/165,012, filed on Mar. 31, 2009.
(60) Provisional application No. 61/115,558, filed on Nov. 18, 2008.

(51) Int. Cl. F16L 9/14; F17C 1/00

(52) U.S. Cl. 138/140; 220/587

(57) ABSTRACT

Compressed hydrogen gas can be stored and transferred in hollow structures with walls that include at least one layer or interlayer of at least one porous metal, the purpose of the latter being to protect one or more surrounding layers from the damage that can be caused by diffusive flux of hydrogen gas. The masses of hydrogen gas that enter the layer(s)/interlayer(s) of the porous metal(s) are continuously or periodically removed from the interconnected pore space in the layer(s)/interlayer(s) of the porous metal(s) to ensure that the pressure(s) of the hydrogen gas remain(s) low—generally less than or equal to one atmosphere. When the structure that holds compressed hydrogen gas is a cylindrical pressure vessel, pipe or pipeline, a manufacturing technique known as “C-forming” can be used to create a wall that contains at least one layer or interlayer of at least one porous metal.

### CROSS-REFERENCE TO RELATED PATENT APPLICATIONS

This application is a continuation-in-part and claims priority to commonly owned:
U.S. patent application Ser. No. 11/852,364, filed Sep. 10, 2007; entitled “Mitigating Hydrogen Flux Through Solid and Liquid Barrier Materials” by James G. Blencoe and Simon L. Marshall;

furthermore, this application claims priority to commonly owned:
U.S. Provisional Patent Application Ser. No. 61/165,012; filed Mar. 31, 2009; entitled “Polymer/Metal Pipe Compositions and Methods,” by James G. Blencoe; and
U.S. Provisional Patent Application Ser. No. 61/115,558; filed Nov. 18, 2008; entitled “New Polymer/Metal Pipe Technologies for Pipeline-Connected Offboard Hydrogen Storage,” by James G. Blencoe;

all of which are hereby incorporated by reference herein for all purposes.

### TECHNICAL FIELD

The present disclosure relates generally to structures for storing and transferring hydrogen gas, and more particularly, to layers/interlayers of solid materials in the walls of those structures that substantially reduce diffusive flux of hydrogen gas therethrough.

### BACKGROUND

A major concern in storing and transferring compressed hydrogen gas in hollow structures is damage to the walls of those structures that can occur due to diffusive flux of hydrogen gas. This problem is especially acute in the case of large, cylindrical pressure vessels for stationary (“offboard”) hydrogen storage, and long pipelines for high-capacity hydrogen transfer, because these structures are typically manufactured from carbon steel, which is known to be vulnerable to hydrogen embrittlement. In carbon steels (and also in stainless steels, but generally to a lesser severity), hydrogen embrittlement is typically manifested by surface cracking, crack propagation, decreases in tensile strength, and loss of ductility. This degradation can lead to leakage, or explosive release, of hydrogen gas from the pressure vessel, or from one or more segments of a hydrogen pipeline. In view of these risks, it is not surprising that qualification of carbon steels for hydrogen storage and transfer at high gas pressures (generally >500 psi) is currently an area of active research and development. Finally, while the effects of diffusive hydrogen flux on polymeric containment (“barrier”) materials, and carbon fiber wrappings, are poorly known compared to carbon and stainless steels, significant long-term negative impacts on those materials, such as hydrogen-induced cracking and chemical degradation, are a real possibility.

### SUMMARY

The invention pertains primarily to containment and transfer of hydrogen gas in hollow cylinders (tubes). However, some embodiments of the invention involve storage of hydrogen gas in, or movement of hydrogen gas through, hollow structures of non-cylindrical form—e.g., spheres, cubes, rectangular prisms, round “tunnels” with flat floors, and various types of enclosures that have more than six flat, round or curved sides. Transfer of hydrogen gas includes transmission, distribution, dispensation or any other form of “delivery” of hydrogen gas at any length scale.

Hollow Composite Structures for Hydrogen Storage and Transfer

The teachings of this disclosure relate to storage±(±=“with or without”) transfer of hydrogen gas in containers with one or more walls that are multi-layered, comprising (proceeding from the outermost layer to the innermost layer): (1) a single layer, or a composite layer (below, an “outer layer”), that consists of, or includes, at least one layer, interlayer or “wrapping” that is sufficiently strong to allow hydrogen gas to be stored±transferred at a pressure greater than or equal to one atmosphere; (2) a single layer, or a composite layer (below, a “middle layer”), that consists of, or includes, at least one layer or interlayer of at least one porous metal (e.g., porous stainless steel); and (3) a single layer, or a composite layer (below, an “inner layer”), that consists of, or includes, at least one layer or interlayer that impedes the diffusive flux of hydrogen gas through the wall(s) of the container.

Possible materials of construction for the outer layer include, but are not restricted to, one or more of: a glass or Kevlar (Kevlar, poly paraphenylene terephthalamide, is a registered trademark of E. I. du Pont de Nemours and Company, a Delaware Corporation, at 1007 Market Street, Wilmington, Del. 19898) fiber-reinforced thermoplastic; strands (“tows”) of glass or Kevlar fiber; resin-embedded carbon fiber; and a high-strength metal such as carbon steel or stainless steel. The small masses of hydrogen gas that diffuse into the layer or interlayer(s) of porous metal in the middle layer are: first, “captured” by that layer or interlayer, or those interlayers, of porous metal(s); and subsequently, either continuously or periodically removed from the interconnected pore space in the layer or interlayer(s) of the porous metal(s) (e.g., by venting or vacuum pumping) to ensure that the pressure(s) of the hydrogen gas in that layer or interlayer, or those interlayers, of porous metal(s) remain(s) low—generally less than or equal to one atmosphere. Possible materials of construction for the inner layer include, but are not limited to, one or more of: high-density polyethylene (HDPE), aluminum (Al), copper (Cu), and stainless steel.

The use of “C-Forming” to Create Composite Tubes for Hydrogen Storage and Transfer

When the container for hydrogen storage±transfer is a hollow cylinder, a manufacturing technique developed for lining pipes known as “C-forming” can be used to create composite tubes in an efficient and cost-effective manner. In this procedure, a (usually thin-walled) hollow cylinder (“liner”) of one kind or another is: first, deformed (“C-formed”) to reduce its effective outside diameter; and subsequently, pulled through the interior of an outer hollow cylinder (e.g., a carbon steel “host pipe”). The walls of the liner and outer hollow cylinder can be single-layered or multi-layered. Moreover, the outer hollow cylinder can be lined more than once by repeating the steps used to create the first liner. Regardless of the number of times the outer hollow cylinder is lined in the manner just described, the final step is always rerounding of the C-formed liner(s). This is accomplished by plugging the two open ends of the innermost liner, and subsequently injecting compressed gas (e.g., dry nitrogen) into the interior of that liner. This inflates the innermost liner, causing it to press up against the next innermost hollow cylinder, which is either the outer hollow cylinder, or another C-formed liner that was previously pulled through the outer hollow cylinder. Rerounding produces a single, composite pipe with a wall that includes at least one liner—the preselected material(s) of construction for the liner(s) being such that the overall performance of the composite pipe in storing±transferring hydrogen gas is enhanced in one or more ways.

According to a specific example embodiment of this disclosure, a composite structure for containing±transferring hydrogen gas comprises: a high-density polyethylene (HDPE) layer formed to surround the hydrogen gas; a porous stainless steel layer formed to surround the HDPE layer; and a carbon steel layer formed to surround the porous stainless steel layer.

According to another specific example embodiment of this disclosure, a composite structure for containing±transferring hydrogen gas comprises: an aluminum layer formed to surround the hydrogen gas; a porous stainless steel layer formed to surround the aluminum layer; and a carbon steel layer formed to surround the porous stainless steel layer.

According to yet another specific example embodiment of this disclosure, a composite structure for containing±transferring hydrogen gas comprises: a first high-density polyethylene (HDPE) layer formed to surround the hydrogen gas; an aluminum layer formed to surround the first HDPE layer; a second HDPE layer formed to surround the aluminum layer; a porous stainless steel layer formed to surround the second HDPE layer; and a carbon steel layer formed to surround the porous stainless steel layer.

According to still another specific example embodiment of this disclosure, a composite structure for containing±transferring hydrogen gas comprises: an aluminum layer formed to surround the hydrogen gas; an aluminum-infused porous stainless steel layer formed to surround the aluminum layer; and a carbon steel layer formed to surround the aluminum-infused porous stainless steel layer.

According to another specific example embodiment of this disclosure, a composite structure for containing±transferring hydrogen gas comprises: an aluminum layer formed to surround the hydrogen gas; an aluminum-infused porous stainless steel layer formed to surround the aluminum layer; and a fiber-reinforced polymer (FRP) layer formed to surround the aluminum-infused porous stainless steel layer.

According to another specific example embodiment of this disclosure, a composite structure for containing±transferring hydrogen gas comprises: an aluminum-infused porous stainless steel layer formed to surround the hydrogen gas; an aluminum layer formed to surround the aluminum-infused porous stainless steel layer; and a fiber-reinforced polymer (FRP) layer formed to surround the aluminum-infused porous stainless steel layer.

According to another specific example embodiment of this disclosure, a composite pipe for containing±transferring hydrogen gas comprises: a first high-density polyethylene (HDPE) layer formed to surround hydrogen gas; an aluminum layer formed to surround the first HDPE layer; and a second HDPE layer formed to surround the aluminum layer, wherein the first HDPE, aluminum and second HDPE layers are C-formed for insertion into a pipe.

### DRAWINGS

A more complete understanding of the present disclosure thereof may be acquired by referring to the following description taken in conjunction with the accompanying drawings wherein:

FIGS. 1-11 illustrate longitudinal cross-sections of pipes with multi-layered walls, with or without a layer of aluminum oxide on the layer/interlayer of aluminum (when present), and/or aluminum-infused porous stainless steel (when present), according to specific example embodiments of this disclosure;

FIG. 12 illustrates transverse cross-sections of (a) a severely deformed (“C-formed”) pipe with a three-layer wall, and (b) a slightly deformed (“C-formed”) pipe with a three-layer wall; and

FIG. 13 illustrates a roller machine that deforms (“C-forms”) pipes that are pulled through the machine as the roller rotates.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

Referring now to the drawings, the details of example embodiments are schematically illustrated. Like elements in the drawings are represented by like numbers, and similar elements are represented by like numbers with a different lower case letter suffix.

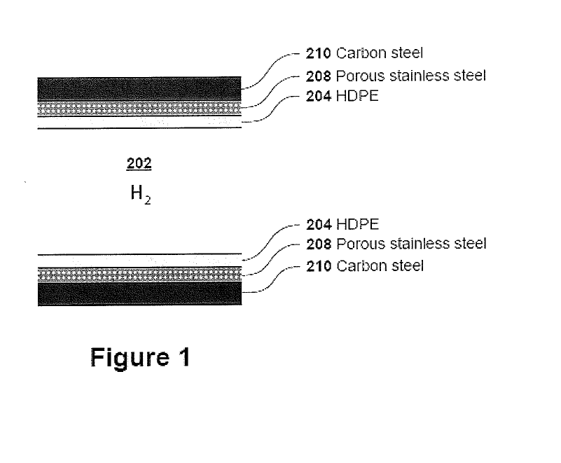

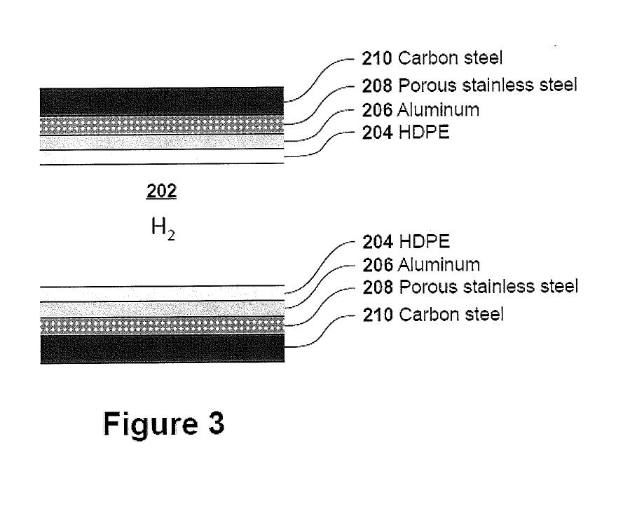

Referring to FIGS. 1-4, depicted are schematic diagrams of longitudinal cross-sections of pipes (tubes) with multi-layered walls, according to specific example embodiments of this disclosure. The diameter of the hollow part of each pipe, and the thicknesses of the individual layers in the wall of each pipe, are schematically shown for purposes of illustration and do not necessarily represent actual thicknesses thereof. Moreover, in each figure, the juxtaposition of the 3-5 layers in the wall of each pipe indicates that the layers of high-density polyethylene (HDPE) 204, 204a and 204b, aluminum 206, porous stainless steel 208, and carbon steel 210, are pressed together tightly to create a single, multi-layered wall.

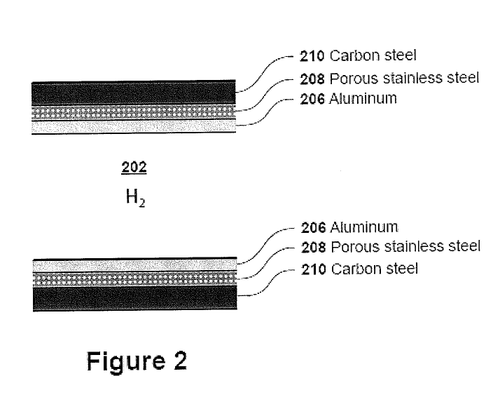

According to the teachings of this disclosure, diffusive flux of hydrogen gas 202 through the wall of each pipe (FIGS. 1-4) is impeded primarily by the layer(s)/interlayer(s) of HDPE (204, 204a and 204b) and aluminum 206. It is also contemplated and within the scope of this disclosure that to further deter hydrogen diffusive flux, the inner and/or outer surfaces of the aluminum layer/interlayer 206 may be oxidized prior to, during, or after creation of the pipe structures depicted in FIGS. 2-4.

Because aluminum has a very low “equilibrium” (steady-state) hydrogen permeability, a layer or interlayer of aluminum±aluminum oxide in the wall of a composite pipe can be very effective in deterring hydrogen diffusion, according to the teachings of this disclosure. This is so because, when the wall of a composite pipe (e.g., see FIGS. 2-4) becomes saturated with hydrogen at a constant internal hydrogen pressure—i.e., reaches “equilibrium” (steady-state) conditions—the thicknesses of the individual layers are no longer a factor in determining the overall rate of hydrogen flux and, in this circumstance, a thin aluminum±aluminum oxide layer/interlayer 206 is as effective as a thick aluminum±aluminum oxide layer/interlayer 206 in slowing the overall rate of hydrogen escape through the wall of the pipe.

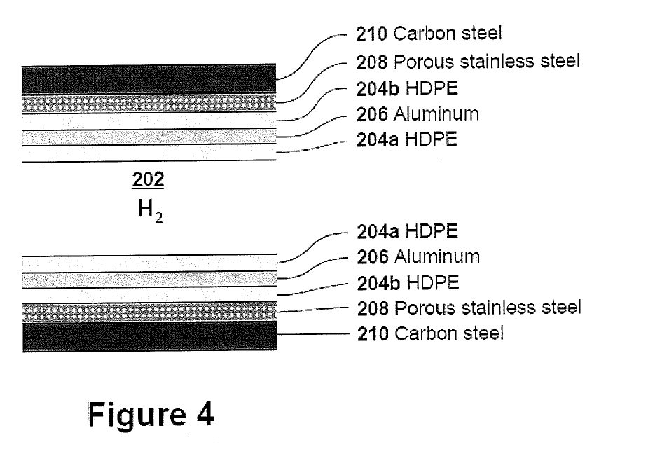

In addition, by virtue of its ease of fabrication and installation, and its durability, a three-layer HDPE/aluminum±aluminum oxide/HDPE structure (e.g., see FIG. 4) could prove to be a particularly attractive option for impeding diffusive hydrogen flux through the walls of composite pipes, because the inner and outer layers of HDPE (204a and 204b in FIG. 4) will substantially protect the aluminum±aluminum oxide interlayer from mechanical abrasion and chemical attack.

It is also contemplated and within the scope of this disclosure: first, that the interlayers of porous stainless steel 208 in FIGS. 1-4 will “capture” the small masses of hydrogen gas that slowly diffuse through the layer(s)/interlayer(s) of HDPE 204, 204a and 204b, and aluminum 206; and second, that the small masses of hydrogen gas that flow into the interconnected pore space in the interlayers of porous stainless steel 208 will be removed from that pore space continuously or periodically by, for example but not limited to, venting or vacuum pumping, to ensure that the pressure of hydrogen gas in the interlayers of porous stainless steel 208 does not rise to an “excessively high” level. An “excessively high” level of hydrogen gas pressure in the interconnected pore space of an interlayer of porous stainless steel 208 would be that pressure of hydrogen gas that would pose a threat to the structural integrity of the surrounding layer of carbon steel 210. For example, an “excessively high” level of hydrogen gas pressure in the interconnected pore space of an interlayer of porous stainless steel 208 would have the potential to embrittle the surrounding layer of carbon steel 210. Hydrogen embrittlement of carbon steel is typically manifested by surface cracking, crack propagation, decreases in tensile strength, and loss of ductility.

It is further contemplated and within the scope of this disclosure that the outer layer of carbon steel 210 in FIGS. 1-4 provides most of the structural strength that is necessary to safely store or transfer hydrogen gas 202.

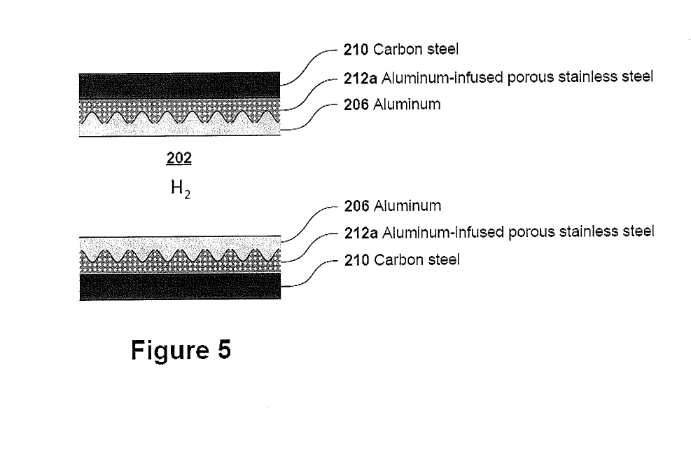

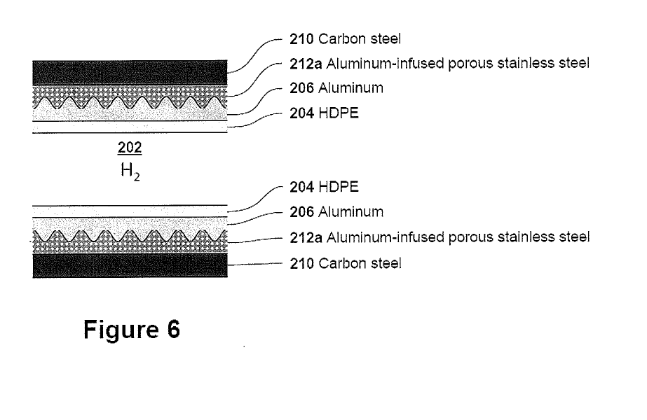

Referring to FIGS. 5 and 6, depicted are schematic diagrams of longitudinal cross-sections of pipes (tubes) with multi-layered walls, according to specific example embodiments of this disclosure. The diameter of the hollow part of each pipe, and the thicknesses of the individual layers in the wall of each pipe, are schematically shown for purposes of illustration and do not necessarily represent actual thicknesses thereof. Moreover, in each figure, the juxtaposition of the 3-4 layers in the wall of each pipe indicates that the layers of HDPE 204, aluminum 206, aluminum-infused porous stainless steel 212a, and carbon steel 210, are pressed together tightly to create a single, multi-layered wall.

According to the teachings of this disclosure, diffusive flux of hydrogen gas 202 through the wall of each pipe (FIGS. 5 and 6) is impeded primarily by the layer(s)/interlayer(s) of HDPE 204, aluminum 206, and aluminum-infused porous stainless steel 212a. It is also contemplated and within the scope of this disclosure that to further deter hydrogen diffusive flux, the inner and/or outer surfaces of the aluminum layer/interlayer 206, and the aluminum-infused porous stainless steel interlayer 212a, may be oxidized prior to, during, or after creation of the pipe structures depicted in FIGS. 5 and 6.

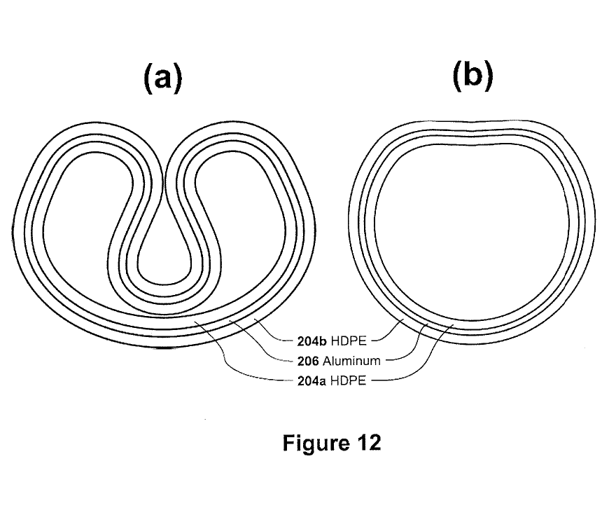

It is further contemplated and within the scope of this disclosure that infusion of aluminum into the aluminum-infused porous stainless steel interlayer 212a can occur prior to, during or after emplacement of that interlayer in the pipe structures depicted in FIGS. 5 and 6. For example, the interlayer of aluminum-infused porous stainless steel 212a can be created in a stepwise manner as follows. First, a thin-walled hollow cylinder of porous stainless steel is manufactured using techniques that are familiar to those skilled in the art. Next, the cylinder of porous stainless steel is deformed (“C-formed”) slightly (see FIG. 12(b)) to reduce its effective diameter by an amount that is sufficient to allow the cylinder to be pulled into the interior of an outer hollow cylinder, which is represented in longitudinal cross-section by carbon steel layer 210 in FIGS. 5 and 6. Finally, a device or machine that sprays molten aluminum onto the inner surface of the cylinder of porous stainless steel is pulled through the interior of that cylinder. The initial mass of molten aluminum sprayed onto the inner surface of the cylinder of porous stainless steel penetrates into the innermost interconnected pore space of that cylinder. Continued spraying of molten aluminum onto the inner surface of the cylinder of porous stainless steel creates a layer of aluminum, represented by the layer/interlayer of aluminum 206 in FIGS. 5 and 6, which covers the inner surface of the cylinder of aluminum-infused porous stainless steel.

It is also contemplated and within the scope of this disclosure: first, that the interlayers of aluminum-infused porous stainless steel 212a in FIGS. 5 and 6 will “capture” the small masses of hydrogen gas that slowly diffuse through the layers/interlayer of HDPE 204, and aluminum 206; and second, that the small masses of hydrogen gas that flow into the interconnected pore space in the interlayers of aluminum-infused porous stainless steel 212a will be removed from that pore space continuously or periodically by, for example but not limited to, venting or vacuum pumping, to ensure that the pressure of hydrogen gas in the interlayers of aluminum-infused porous stainless steel 212a does not rise to an “excessively high” level. An “excessively high” level of hydrogen gas pressure in the interconnected pore space of an interlayer of aluminum-infused porous stainless steel 212a would be that pressure of hydrogen gas that would pose a threat to the structural integrity of the surrounding layer of carbon steel 210. For example, an “excessively high” level of hydrogen gas pressure in the interconnected pore space of an interlayer of aluminum-infused porous stainless steel 212a would have the potential to embrittle the surrounding layer of carbon steel 210.

It is further contemplated and within the scope of this disclosure that the outer layer of carbon steel 210 in FIGS. 5 and 6 provides most of the structural strength that is necessary to safely store or transfer hydrogen gas 202.

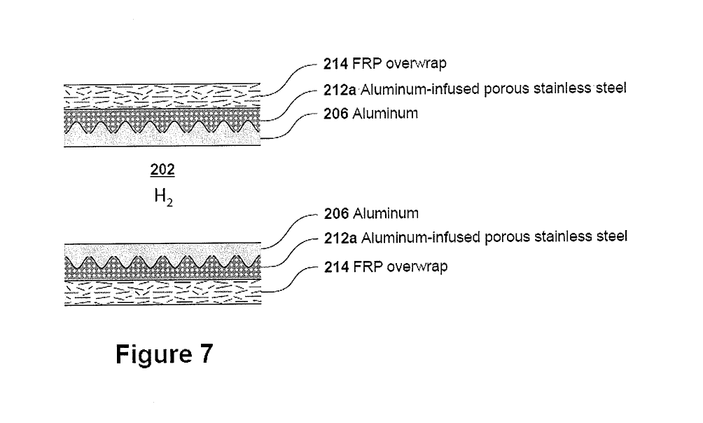

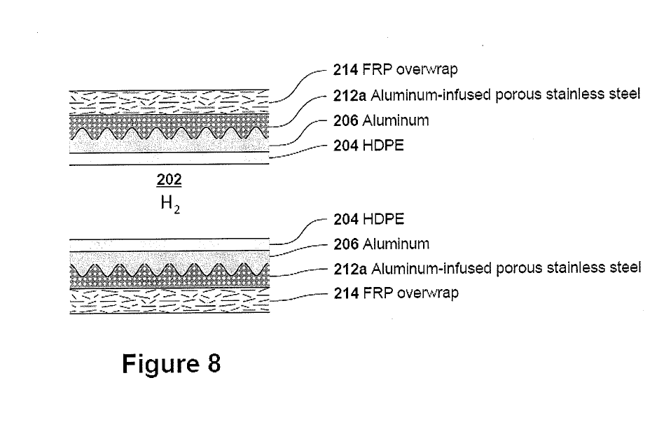

Referring to FIGS. 7 and 8, depicted are schematic diagrams of longitudinal cross-sections of pipes (tubes) with multi-layered walls, according to specific example embodiments of this disclosure. The diameter of the hollow part of each pipe, and the thicknesses of the individual layers in the wall of each pipe, are schematically shown for purposes of illustration and do not necessarily represent actual thicknesses thereof. Moreover, in each figure, the juxtaposition of the 3-4 layers in the wall of each pipe indicates that the layer(s) of HDPE 204, aluminum 206, aluminum-infused porous stainless steel 212a, and FRP (fiber-reinforced polymer) overwrap 214, are pressed together tightly to create a single, multi-layered wall.

According to the teachings of this disclosure, diffusive flux of hydrogen gas 202 through the wall of each pipe (FIGS. 7 and 8) is impeded primarily by the layer(s)/interlayer(s) of HDPE 204, aluminum 206, and aluminum-infused porous stainless steel 212a. It is also contemplated and within the scope of this disclosure that to further deter hydrogen diffusive flux, the inner and/or outer surfaces of the aluminum layer/interlayer 206, and the aluminum-infused porous stainless steel layer 212a, may be oxidized prior to, during, or after creation of the pipe structures depicted in FIGS. 7 and 8.

It is further contemplated and within the scope of this disclosure that infusion of aluminum into the aluminum-infused porous stainless steel interlayer 212a can occur prior to, during or after emplacement of that interlayer in the pipe structures depicted in FIGS. 7 and 8. For example, the interlayer of aluminum-infused porous stainless steel 212a can be created in a stepwise manner as follows. First, a thin-walled hollow cylinder of porous stainless steel is manufactured using techniques that are familiar to those skilled in the art. Next, the cylinder of porous stainless steel is deformed (“C-formed”) slightly (see FIG. 12(b)) to reduce its effective diameter by an amount that is sufficient to allow the cylinder to be pulled into the interior of an outer hollow cylinder, which is represented in longitudinal cross-section by FRP overwrap 214 in FIGS. 7 and 8. Finally, a device or machine that sprays molten aluminum onto the inner surface of the cylinder of porous stainless steel is pulled through the interior of that cylinder. The initial mass of molten aluminum sprayed onto the inner surface of the cylinder of porous stainless steel penetrates into the innermost interconnected pore space of that cylinder. Continued spraying of molten aluminum onto the inner surface of the cylinder of porous stainless steel creates a layer of aluminum, represented by the layer/interlayer of aluminum 206 in FIGS. 7 and 8, which covers the inner surface of the cylinder of aluminum-infused porous stainless steel.

It is also contemplated and within the scope of this disclosure: first, that the interlayers of aluminum-infused porous stainless steel 212a in FIGS. 7 and 8 will “capture” the small masses of hydrogen gas that slowly diffuse through the layers/interlayer of HDPE 204, and aluminum 206; and second, that the small masses of hydrogen gas that flow into the interconnected pore space in the interlayers of aluminum-infused porous stainless steel 212a will be removed from that pore space continuously or periodically by, for example but not limited to, venting or vacuum pumping, to ensure that the pressure of hydrogen gas in the interlayers of aluminum-infused porous stainless steel 212a does not rise to an “excessively high” level. An “excessively high” level of hydrogen gas pressure in the interconnected pore space of an interlayer of aluminum-infused porous stainless steel 212a would be that pressure of hydrogen gas that would pose a threat to the structural integrity of the surrounding FRP overwrap 214. For example, an “excessively high” level of hydrogen gas pressure in the interconnected pore space of an interlayer of aluminum-infused porous stainless steel 212a would have the potential to embrittle or otherwise damage the surrounding FRP overwrap 214.

It is further contemplated and within the scope of this disclosure that the FRP overwrap 214 in FIGS. 7 and 8 provides most of the structural strength that is necessary to safely store or transfer hydrogen gas 202 at desired pressures.

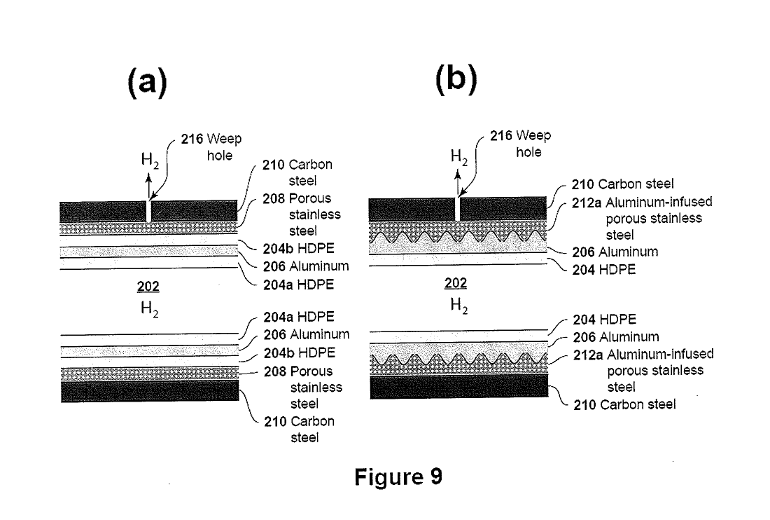

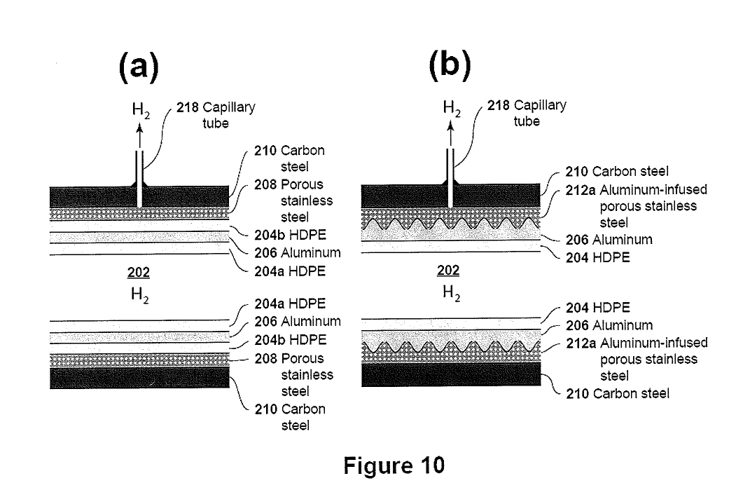

Referring to FIGS. 1-8, 9 and 10, it is further contemplated and within the scope of this disclosure that the small masses of hydrogen gas that accumulate in the interconnected pore space in the porous stainless steel interlayer 208 (FIGS. 1-4, 9 and 10) and aluminum-infused porous stainless steel 212a (FIGS. 5-8, 9 and 10), can be vented, vacuum-pumped, or otherwise removed from the porous stainless steel interlayer 208 and aluminum-infused porous stainless steel interlayer 212a through one or more narrow-diameter holes (“weep holes” 216 in FIG. 9) in the surrounding layer of carbon steel 210 (FIGS. 1-6 and 9) and/or FRP overwrap 214 (FIGS. 7 and 8). Weep holes 216 could be, for example but not limited to, drilled through the outer layer of carbon steel 210 (e.g., FIG. 9) at about a 90 degree angle to the outer surface of that layer, extending all of the way through that layere—e.g., to the inner surface of that layer—thereby creating a narrow-diameter cylindrical pathway for removal of free-flowing hydrogen gas present in the interconnected pore space in the porous stainless steel interlayer 208 and aluminum-infused porous stainless steel interlayer 212a. Finally, to enable continuous gathering of the small masses of hydrogen gas that flow through one or more weep holes that are drilled through the layer of carbon steel 210 (FIGS. 1-6 and 9), each weep hole could be “filled” with a capillary tube 218 (see FIG. 10) that is connected to the layer of carbon steel 210 by welding. In this circumstance, the small masses of hydrogen gas that flow out of the porous stainless steel interlayer 208 (FIG. 10(a)) and/or aluminum-infused porous stainless steel interlayer 212a (FIG. 10(b)) travel through the interior of the capillary tube 218 (FIG. 10) that has been attached, e.g., welded, into the previously drilled weep hole 216 (FIG. 9). This small mass of hydrogen gas from the capillary tube(s) 218 may be vented to the atmosphere and/or collected in a collection chamber (not shown).

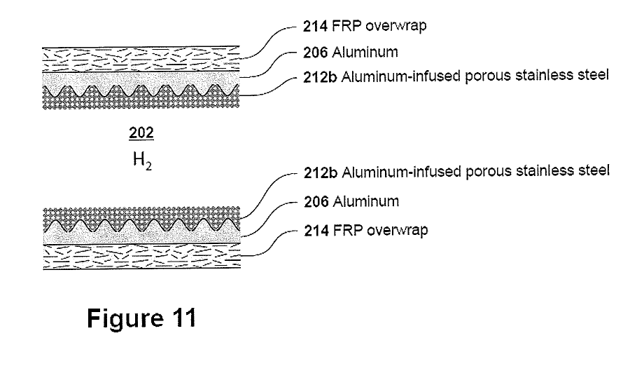

Referring to FIG. 11, depicted is a schematic diagram of a longitudinal cross-section of a pipe (tube) with a multi-layered wall, according to a specific example embodiment of this disclosure. The diameter of the hollow part of the pipe, and the thicknesses of the individual layers in the wall of the pipe, are schematically shown for purposes of illustration and do not necessarily represent actual thicknesses thereof. Moreover, the juxtaposition of the three layers in the wall of the pipe indicates that the layers of aluminum-infused porous stainless steel 212b, aluminum 206, and FRP overwrap 214, are pressed together tightly to create a single, multi-layered wall.

According to the teachings of this disclosure, diffusive flux of hydrogen gas 202 through the wall of the pipe (FIG. 11) is impeded primarily by the layer of aluminum-infused porous stainless steel 212b, and the aluminum interlayer 206. It is also contemplated and within the scope of this disclosure that to further deter hydrogen diffusive flux, the inner and/or outer surfaces of the aluminum-infused porous stainless steel interlayer 212b, and the aluminum interlayer 206, may be oxidized prior to, during, or after creation of the pipe structure depicted in FIG. 11.

It is further contemplated and within the scope of this disclosure that infusion of aluminum into the aluminum-infused porous stainless steel interlayer 212b must occur prior to emplacement of that innermost layer in the pipe structure depicted in FIG. 11. For example, the layer of aluminum-infused porous stainless steel 212b can be created in a stepwise manner as follows. (1) A thin-walled hollow cylinder of porous stainless steel is manufactured using techniques that are familiar to those skilled in the art. (2) The cylinder of porous stainless steel is deformed (“C-formed”) slightly (see FIG. 12(b)) to reduce its effective diameter by an amount that is sufficient to allow the cylinder to be pulled into the interior of an outer hollow cylinder, which is represented in longitudinal cross-section by the FRP overwrap 214 in FIG. 11. (3) A device or machine that sprays molten aluminum is used to spray molten aluminum onto the outer surface of the cylinder of porous stainless steel. The initial mass of molten aluminum sprayed onto the outer surface of the cylinder of porous stainless steel penetrates into the outermost interconnected pore space of that cylinder. Continued spraying of molten aluminum onto the outer surface of the cylinder of porous stainless steel creates a layer of aluminum, represented by the aluminum interlayer 206 shown in FIG. 11, which covers the outer surface of the cylinder of aluminum-infused porous stainless steel 212b.

It is further contemplated and within the scope of this disclosure that the FRP overwrap 214 in FIG. 11 provides most of the structural strength that is necessary to safely store or transfer hydrogen gas 202 at desired pressures.

Referring to FIG. 12, depicted are transverse cross-sections of: (a) a severely deformed (“C-formed”) pipe (tube) with a three-layer (HDPE 204a/aluminum 206/HDPE 204b) wall; and (b) a slightly deformed (“C-formed”) pipe (tube) with a three-layer (HDPE 204a/aluminum 206/HDPE 204b) wall.

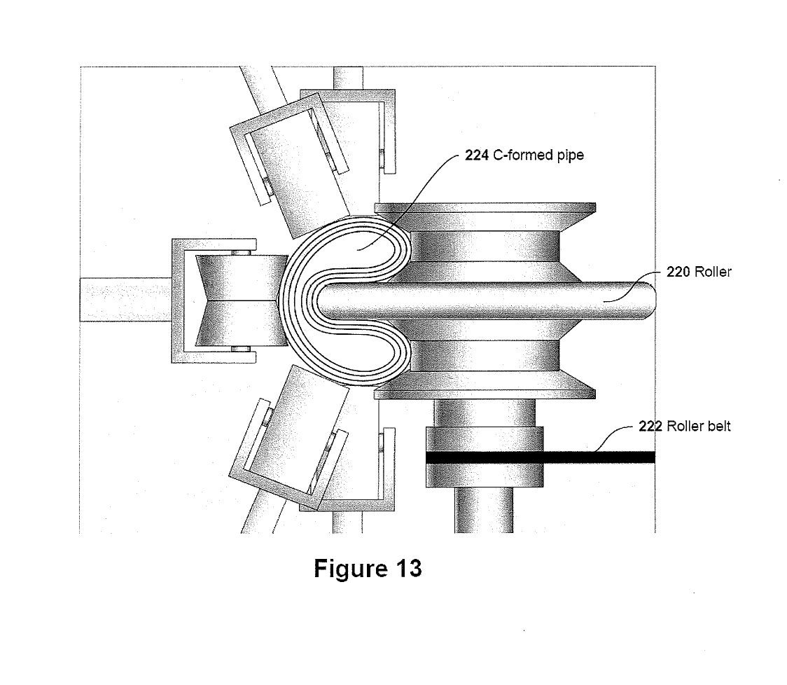

Referring to FIG. 13, depicted is a roller machine that deforms (“C-forms”) pipes (tubes) that are pulled through the machine as the roller 220 rotates. Rotation of the roller 220 is induced by rotation of the roller belt 222. It can be seen in this figure that the shape of the resulting C-formed pipe 224, depicted in transverse cross-section, is very similar to the shape of the C-formed pipe illustrated in FIG. 12(a), which is likewise depicted in transverse cross-section.

It is also contemplated and within the scope of this disclosure that the C-formed hollow cylinder(s) (“liner(s)”) pulled into the interior of an outer hollow cylinder (e.g., a carbon steel “host pipe”), or into the interior of another C-formed hollow cylinder (“liner”), is (are) rerounded after its (their) emplacement. This is accomplished by plugging the two open ends of the innermost hollow cylinder, and subsequently injecting compressed gas (e.g., dry nitrogen) into the interior of that cylinder. This inflates the innermost hollow cylinder, causing it to press up against the next innermost hollow cylinder, which is either the outer hollow cylinder, or another C-formed hollow cylinder that was previously pulled through the outer hollow cylinder. Rerounding produces a single, composite pipe with a wall that includes at least two layers—the preselected material(s) of construction for those layers being such that the overall performance of the composite pipe in storing±transferring hydrogen gas is enhanced in one or more ways.

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. A composite structure for containing hydrogen gas, comprising:
a high-density polyethylene (HDPE) layer formed to surround hydrogen gas;
a porous stainless steel layer formed to surround the HDPE layer; and
a carbon steel layer formed to surround the porous stainless steel layer.

2. The composite structure according to claim 1, further comprising at least one weep hole in the carbon steel layer and extending therethrough to the porous stainless steel layer, wherein diffused hydrogen gas under pressure flows along the porous stainless steel layer and the diffused hydrogen gas is relieved through the at least one weep hole.

3. The composite structure according to claim 2, wherein the at least one weep hole is approximately perpendicular to a longitudinal axis of the carbon steel layer.

4. The composite structure according to claim 2, further comprising a capillary tube attached to the at least one weep hole.

5. The composite structure according to claim 2, further comprising a capillary tube attached to each one of the at least one weep hole.

6. The composite structure according to claim 4, further comprising a collection chamber for collecting the diffused hydrogen gas relieved through the at least one weep hole and the capillary tube attached thereto.

7. The composite structure according to claim 2, wherein the diffused hydrogen gas relieved through the at least one weep hole is vented to atmosphere.

8. The composite structure according to claim 1, wherein the carbon steel layer is formed into a carbon steel pipe.

9. The composite structure according to claim 8, wherein the HDPE and porous stainless steel layers are C-formed for insertion into the carbon steel pipe.

10. The composite structure according to claim 9, wherein the C-formed HDPE and porous stainless steel layers have pressure applied therein so as to conform to an inner surface of the carbon steel pipe.

11. The composite structure according to claim 10, wherein the pressure is applied with dry nitrogen.

12. A composite structure for containing hydrogen gas, comprising:
an aluminum layer formed to surround hydrogen gas;
a porous stainless steel layer formed to surround the aluminum layer; and
a carbon steel layer formed to surround the porous stainless steel layer.

13. The composite structure according to claim 12, further comprising a high-density polyethylene (HDPE) layer between the aluminum layer and the hydrogen gas, wherein the HDPE layer is formed to surround the hydrogen gas.

14. The composite structure according to claim 12, further comprising at least one weep hole in the carbon steel layer and extending therethrough to the porous stainless steel layer, wherein diffused hydrogen gas under pressure flows along the porous stainless steel layer and the diffused hydrogen gas is relieved through the at least one weep hole.

15. The composite structure according to claim 14, wherein the at least one weep hole is approximately perpendicular to a longitudinal axis of the carbon steel layer.

16. The composite structure according to claim 14, further comprising a capillary tube attached to the at least one weep hole.

17. The composite structure according to claim 14, further comprising a capillary tube attached to each one of the at least one weep hole.

18. The composite structure according to claim 16, further comprising a collection chamber for collecting the diffused hydrogen gas relieved through the at least one weep hole and the capillary tube attached thereto.

19. The composite structure according to claim 14, wherein the diffused hydrogen gas relieved through the at least one weep hole is vented to atmosphere.

20. The composite structure according to claim 12, wherein the carbon steel layer is formed into a carbon steel pipe.

21. The composite structure according to claim 20, wherein the aluminum and porous stainless steel layers are C-formed for insertion into the carbon steel pipe.

22. The composite structure according to claim 21, wherein the C-formed aluminum and porous stainless steel layers have pressure applied therein so as to conform them to an inner surface of the carbon steel pipe.

23. The composite structure according to claim 22, wherein the pressure is applied with dry nitrogen.

24. A composite structure for containing hydrogen gas, comprising:
a first high-density polyethylene (HDPE) layer formed to surround hydrogen gas;
an aluminum layer formed to surround the first HDPE layer;
a second HDPE layer formed to surround the aluminum layer;
a porous stainless steel layer formed to surround the second HDPE layer; and
a carbon steel layer formed to surround the porous stainless steel layer.

25. The composite structure according to claim 24, further comprising at least one weep hole in the carbon steel layer and extending therethrough to the porous stainless steel layer, wherein diffused hydrogen gas under pressure flows along the porous stainless steel layer and the diffused hydrogen gas is relieved through the at least one weep hole.

26. The composite structure according to claim 25, wherein the at least one weep hole is approximately perpendicular to a longitudinal axis of the carbon steel layer.

27. The composite structure according to claim 25, further comprising a capillary tube attached to the at least one weep hole.

28. The composite structure according to claim 25, further comprising a capillary tube attached to each one of the at least one weep hole.

29. The composite structure according to claim 27, further comprising a collection chamber for collecting the diffused hydrogen gas relieved through the at least one weep hole and the capillary tube attached thereto.

30. The composite structure according to claim 25, wherein the diffused hydrogen gas relieved through the at least one weep hole is vented to atmosphere.

31. The composite structure according to claim 24, wherein the carbon steel layer is formed into a carbon steel pipe.

32. The composite structure according to claim 31, wherein the first and second HDPE, aluminum and porous stainless steel layers are C-formed for insertion into the carbon steel pipe.

33. The composite structure according to claim 32, wherein the C-formed first and second HDPE, aluminum and porous stainless steel layers have pressure applied therein so as to conform them to an inner surface of the carbon steel pipe.

34. The composite structure according to claim 33, wherein the pressure is applied with dry nitrogen.

35. A composite structure for containing hydrogen gas, comprising:
an aluminum layer formed to surround hydrogen gas;
an aluminum-infused porous stainless steel layer formed to surround the aluminum layer; and
a carbon steel layer formed to surround the aluminum-infused porous stainless steel layer.

36. The composite structure according to claim 35, further comprising a high-density polyethylene (HDPE) layer between the aluminum layer and the hydrogen gas, wherein the HDPE layer is formed to surround the hydrogen gas.

37. The composite structure according to claim 35, further comprising at least one weep hole in the carbon steel layer and extending therethrough to the aluminum-infused porous stainless steel layer, wherein diffused hydrogen gas under pressure flows along the aluminum-infused porous stainless steel layer and the diffused hydrogen gas is relieved through the at least one weep hole.

38. The composite structure according to claim 37, wherein the at least one weep hole is approximately perpendicular to a longitudinal axis of the carbon steel layer.

39. The composite structure according to claim 37, further comprising a capillary tube attached to the at least one weep hole.

40. The composite structure according to claim 37, further comprising a capillary tube attached to each one of the at least one weep hole.

41. The composite structure according to claim 39, further comprising a collection chamber for collecting the diffused hydrogen gas relieved through the at least one weep hole and the capillary tube attached thereto.

42. The composite structure according to claim 37, wherein the diffused hydrogen gas relieved through the at least one weep hole is vented to atmosphere.

43. The composite structure according to claim 35, wherein the carbon steel layer is formed into a carbon steel pipe.

44. The composite structure according to claim 43, wherein the aluminum and aluminum-infused porous stainless steel layers are C-formed for insertion into the carbon steel pipe.

45. The composite structure according to claim 44, wherein the C-formed aluminum and aluminum-infused porous stainless steel layers have pressure applied therein so as to conform them to an inner surface of the carbon steel pipe.

46. The composite structure according to claim 45, wherein the pressure is applied with dry nitrogen.

47. A composite structure for containing hydrogen gas, comprising:
an aluminum layer formed to surround hydrogen gas;
an aluminum-infused porous stainless steel layer formed to surround the aluminum layer; and
a fiber-reinforced polymer (FRP) layer formed to surround the aluminum-infused porous stainless steel layer.

48. The composite structure according to claim 47, further comprising a high-density polyethylene (HDPE) layer between the aluminum layer and the hydrogen gas, wherein the HDPE layer is formed to surround the hydrogen gas.

49. The composite structure according to claim 47, further comprising at least one weep hole in the FRP layer and extending therethrough to the aluminum-infused porous stainless steel layer, wherein diffused hydrogen gas under pressure flows along the aluminum-infused porous stainless steel layer and the diffused hydrogen gas is relieved through the at least one weep hole.

50. The composite structure according to claim 49, wherein the at least one weep hole is approximately perpendicular to a longitudinal axis of the FRP layer.

51. The composite structure according to claim 49, further comprising a capillary tube attached to the at least one weep hole.

52. The composite structure according to claim 49, further comprising a capillary tube attached to each one of the at least one weep hole.

53. The composite structure according to claim 51, further comprising a collection chamber for collecting the diffused hydrogen gas relieved through the at least one weep hole and the capillary tube attached thereto.

54. The composite structure according to claim 49, wherein the diffused hydrogen gas relieved through the at least one weep hole is vented to atmosphere.

55. A composite structure for containing hydrogen gas, comprising:
an aluminum-infused porous stainless steel layer formed to surround hydrogen gas;
an aluminum layer formed to surround the aluminum-infused porous stainless steel layer; and
a fiber-reinforced polymer (FRP) layer formed to surround the aluminum-infused porous stainless steel.

56. A composite pipe lining structure for containing hydrogen gas, comprising:
a first high-density polyethylene (HDPE) layer formed to surround hydrogen gas;
an aluminum layer formed to surround the first HDPE layer; and
a second HDPE layer formed to surround the aluminum layer,
wherein the first HDPE, aluminum and second HDPE layers are C-formed for insertion into a pipe.

57. The composite pipe lining structure according to claim 56, wherein the C-formed first HDPE, aluminum and second HDPE layers have pressure applied therein so as to conform them to an inner surface of the pipe.
